(19) United States
(12) Patent Application Publication
(10) Pub. No.: US 2015/0205809 A1
(43) Pub. Date: Jul. 23, 2015

(54) Image Obfuscation

(71) Applicant: Pagefair Limited, Dublin (IE)

(72) Inventors: Sean Blanchfield, Dublin (IE); Brian McDonnell, Co. Kildare (IE); Neil O'Connor, Co. Meath (IE)

(73) Assignee: Pagefair Limited, Dublin (IE)

(21) Appl. No.: 14/593,054

(22) Filed: Jan. 9, 2015

Related U.S. Application Data
(60) Provisional application No. 61/928,512, filed on Jan. 17, 2014.

(51) Int. Cl. G06F 17/30; G06F 17/22

(52) U.S. Cl. CPC G06F 17/3089; G06F 17/2247

(57) ABSTRACT

Provided are a method and system for displaying an image on a web page, comprising: a fragmentation engine separating a web page element, which when rendered on the web page has visual characteristics, into a plurality of fragments and generating display instructions for each of the fragments; and a rendering engine arranging the fragments on a web page according to the display instructions to replicate the visual characteristics of the web page element.

### RELATED APPLICATION

The present invention relates to and claims the benefit of priority to U.S. Provisional Patent Application 61/928,512 filed 17 Jan. 2014, which is hereby incorporated by reference in its entirety for all purposes as if fully set forth herein.

### FIELD

The present invention relates in general to methods by which images are displayed in web browsers, and more particularly to methods to ensure that such images cannot easily be identified by prior knowledge of certain attributes.

### BACKGROUND OF THE INVENTION

The most highly visited websites in the world make money through the display of advertising on behalf of other businesses. The global online display advertising market was expected to grow by 20% to nearly $40 billion US dollars in 2013. This advertising expenditure permits websites to provide their content free of charge to consumers.

Ad units are normally displayed in one of a number of standard dimensions, such as those defined by the Interactive Advertising Bureau. It should be understood that “ad unit” refers to a graphical advertising element that is intended to be displayed on a web page. The benefit of standardized dimensions is that advertisers can arrange for a single ad unit to be displayed on many different websites, which have been designed to accommodate an ad of this size.

In recent years, a number of mainstream software tools have emerged that automatically prevent the display of ad units. An exemplar is the “AdBlock” extension, which is used by hundreds of millions of web users. These ad blocking tools augment the behaviour of the web browser, automatically hiding any parts of web pages that possess the dimensions of a standard ad unit. By selectively hiding parts of web pages, these tools act to tamper with the intended user experience. This is detrimental to the businesses that publish this content, whose continued existence depends upon the correct display of advertising alongside the content they produce.

It is necessary to first outline the conventional system and method by which images are displayed on web pages. As would be evident to a skilled person in the art, the term “images” refers to graphical elements such as photographs or drawings, which may be represented in a raster or vector format and may be static or animated. A conventional method by which images are displayed in web browsers is described with reference to FIG. 1, FIG. 2 and FIG. 3. Referring to FIG. 1, a web browser 101 downloads a web page, and then utilises a rendering engine 102 to display it on-screen by reading and interpreting instructions contained in a HTML document.

Web pages consist of a mixture of text and other elements, such as images, video and interactive components. As would be evident to a skilled person in the art, an “element” refers to any one of a number of standard HTML components that may exist in a HTML document, each of which may have any number of additional specified attributes, as set out in the HTML standard.

The structure of a HTML document is best described with reference to FIG. 2. The document consists of a tree-like structure of elements. Starting with a parent element 201, each element contains an ordered list of other elements, each of which may contain yet more elements.

The rendering engine 102 controls the layout and formatting of the text and other elements according to instructions specified in the HTML document. This may be achieved through direct instructions in the HTML document, or by indirect instructions contained in files that the HTML document refers to.

The rendering engine 102 may be configured to display an image using various methods. The most common method is to include a specialised image element 208 in the HTML document, containing an attribute that specifies the URL of an image file to display. Alternatively, any other HTML element may be utilized as a container for the image, by providing instructions to display it with a background image. Additional methods include, but are not limited to, usage of “canvas” elements to contain images, or usage of browser plugins such as Flash and Silverlight, to display images.

The way in which the rendering engine 102 displays images and other elements in FIG. 2 is best described with reference to FIG. 3. FIG. 3 depicts a web page 301, which contains an image element 302 and a number of paragraphs of text 307-311. In comparing FIG. 3 to FIG. 2, the image 302 corresponds to the element 208, and the paragraphs of text 307-311 correspond to the elements 202-207.

The position and size of the image 302 will be determined by the web rendering engine according to standard rules that are agnostic of the precise method by which it is displayed. The image may be considered to have the geometry of a box, possessing both a width 303 and a height 304. Its position on the web page 301 is affected by various optional attributes, such as a minimum margin 305 between it and other displayed elements and a border 306 of a specified thickness. The position of the image may alternatively be explicitly specified with reference to the required distance between it and a parent element.

Ad blocking tools act to tamper with web pages by examining the width and height of elements, thereby identifying and hiding those that match standard ad unit dimensions.

There is however a desire in certain environments to overcome these actions of ad blocking tools. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY

In order to address problems associated with ad blocking tools the inventors have found that if an element that displays an advertising image does not possess standard ad unit dimensions, that these tools cannot identify it, and therefore cannot automatically hide it. Within the context of the present teaching the term “image” means any web page element which when rendered on a web page has visual characteristics. This may include but is not limited to image of the type .jpg, .gif. tiff, etc.

The present teaching provides a method and system to prevent advertising images on web pages being automatically removed using prior knowledge of their screen dimensions.

Accordingly, the present teaching provides a method as detailed in claim 1. The application also provides a system as detailed in claim 15. Advantageous features are provided in the dependent claims. The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 is a diagram depicting the interaction between components of a conventional system by which web content is delivered to clients;

FIG. 2 is a block diagram depicting how a rendering engine renders images and other elements of a web page;

FIG. 3 depicts a web page containing an image element and a number of paragraphs of text;

FIG. 4 is a block diagram illustrating components of a system of the present teaching by which web content is delivered to clients;

FIG. 5 is a diagram illustrating an image segmented once at a random x-axis coordinate and once at a random y-axis coordinate to produce four fragments;

FIG. 6 is a diagram illustrating an image segmented twice at random x-axis coordinates and twice at random y-axis coordinates to produce nine fragments

FIG. 7 is a diagram illustrating how each fragment of an image may be further sub-fragmented into sub-fragments;

FIG. 8 is a diagram illustrating how each fragment of an image may be further fragmented recursively into multiple sub-fragments;

FIG. 9 is a diagram illustrating an image segmented twice at random angles of inclination to produce four fragments;

FIG. 10 is a diagram illustrating an image segmented along irregular non-linear paths through the image to produce five fragments;

FIG. 11 is a diagram illustrating an image segmented along curved lines through the image to produce five fragments;

FIG. 12 is a block diagram depicting how a fragment layout engine can arrange fragments for correct visual display; and

FIG. 13 shows how fragments are rearranged into position over the location of a transparent element of the web page so as to produce the original image.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Exemplary arrangements of a method and system provided in accordance with the present teaching will be described hereinafter to assist with an understanding of the benefits of the present teaching. Such a method and system may be understood as being exemplary of the types of methods and systems that could be provided and are not intended to limit the present teaching to any one specific arrangement as modifications could be made to that described herein without departing from the scope of the present teaching.

The present teaching provides a method and system to prevent advertising images on web pages being automatically removed using prior knowledge of their screen dimensions.

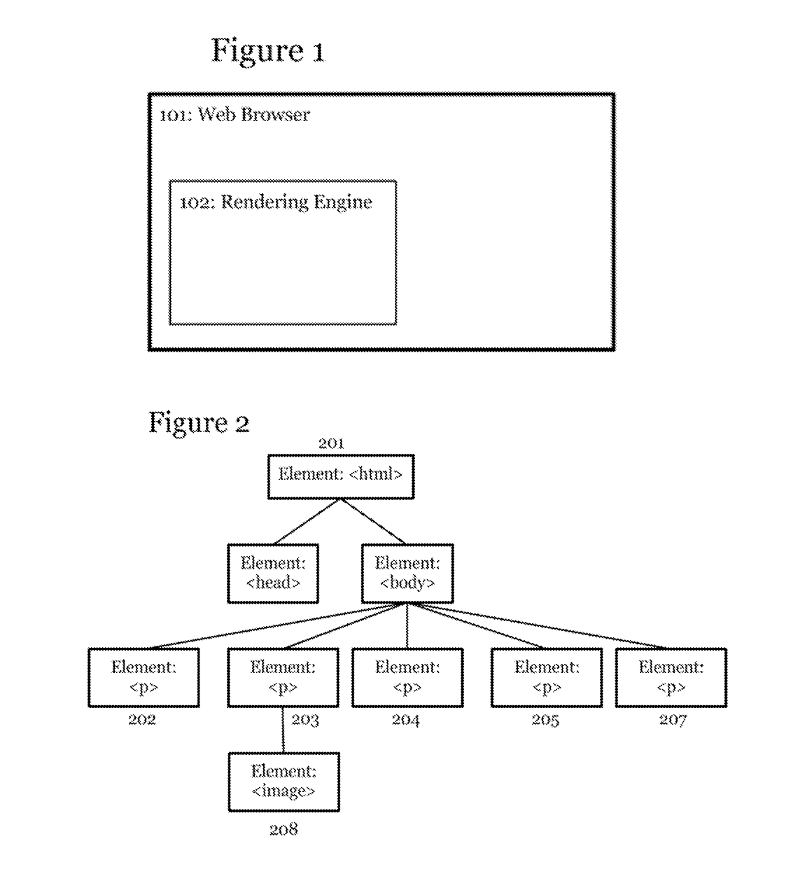

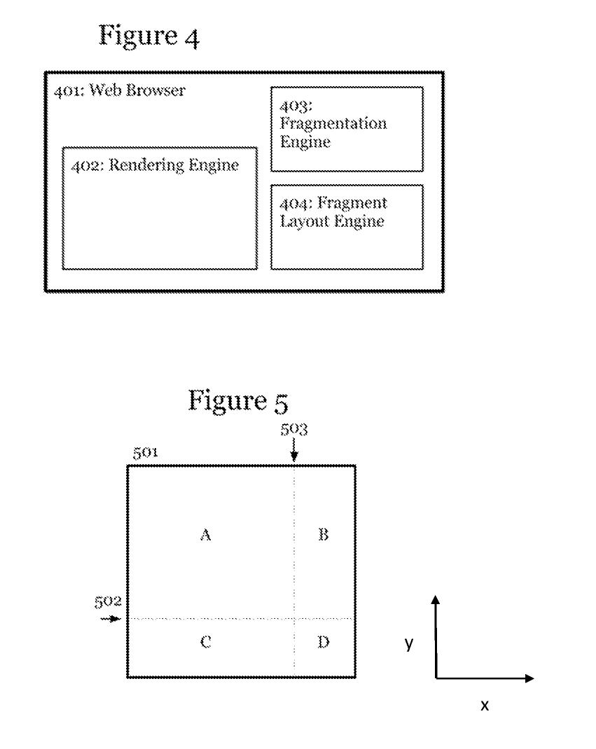

The teachings of the present application require the introduction of new components to the conventional system described in FIG. 1. FIG. 4 is a block diagram illustrating components of a system of the present teaching by which web content is delivered to clients. Referring to FIG. 4, the system includes a web browser 401, a rendering engine 402, a fragmentation engine 403 and a fragment layout engine 404. The functionality of the fragmentation engine and the fragment layout engine maybe integrated into one functional element generically termed the fragmentation engine. The web browser 401 downloads a web page including at least one image, and the rendering engine 402 is used to display the web page, such as a HTML document, on-screen. The rendering engine may be provided as a plug-in or other executable application that functions in combination with existing functionality of a web page browser. In order to render the image on-screen, the image is fragmented and rearranged as follows. The fragmentation engine 403 separates the image into a plurality of fragments of random dimensions, thereby making them unidentifiable on the basis of their width or height. The fragment layout engine 404 produces display instructions that cause the rendering engine 402 to arrange the fragments in such a way that they visually resemble the original image. It should be understood that the term “fragment” refers to a part of an image as displayed on a screen. The smallest possible fragment represents one pixel of an image, and the largest possible fragment represents a group of pixels shorter in width or height by one pixel than the whole image.

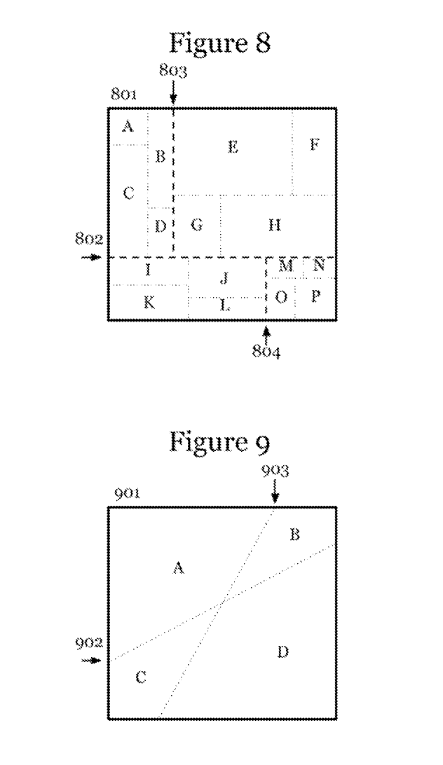

The fragmentation engine 403 may produce fragments from the image in a number of ways. The fragmentation engine 403 may produce fragments by segmenting the image along one or more lines between the image borders. Referring to FIG. 5, the image may be considered to have the geometry of a box, possessing both a width and a height. Thus, the image may have left, right, top and bottom borders. For example, the image may be segmented at at least one random position on a top border and left border of the image. The fragments obtained may have the same or different dimensions to each other. This is illustrated in FIG. 8 as explained below.

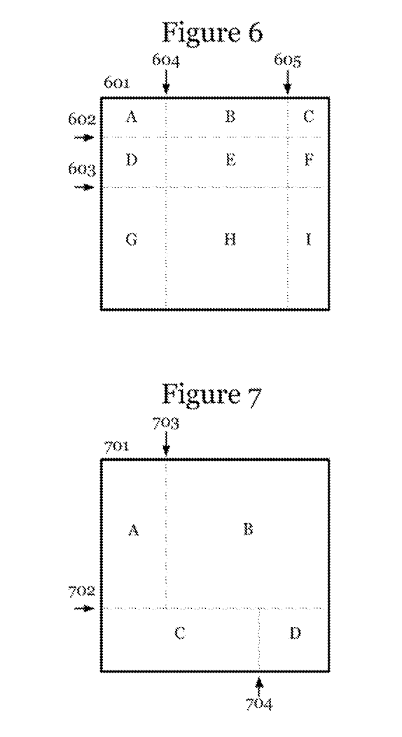

In one embodiment, the image may be randomly segmented at random positions on any of the borders of the image. The image may be segmented in at least one of an x-axis plane and a y-axis plane, as illustrated in FIG. 5. This is best described with reference to the embodiment of FIG. 5. Referring to FIG. 5, an image 501 is segmented once at a coordinate 502 in an x-axis plane, for example in a line parallel to the top and bottom borders, and once at a random coordinate 503 in a y-axis plane, for example in a line parallel to the left and right borders, to produce four fragments (A, B, C and D). FIG. 6 depicts the same method extended to two lines in each of the x-axis and y-axis planes. The fragmentation engine 403 may process an image 601 by performing two segmenting steps in the x-axis plane (602, 603) and two segmenting steps in the y-axis plane (604, 605) to produce nine fragments (A through I). The methods depicted in FIG. 5 and FIG. 6 may be similarly extended to any number of segmenting steps.

In another embodiment, each fragment may be further sub-fragmented. This is best understood with reference to FIG. 7. The fragmentation engine 403 first segments an image 701 at 702 to produce two fragments. Each of these fragments is then independently segmented again, first at 703 to produce fragments A and B, and then at 704 to produce fragments C and D. The fragments thus produced have the benefit of greater heterogeneity with respect to those produced by the method employed in FIG. 5 and FIG. 6. In this embodiment, the fragmentation engine 403 may recursively repeat the fragmentation procedure. This is best described with reference to FIG. 8. Referring to FIG. 8, an image 801 corresponds to the image 701 in FIG. 7, with similar segmenting steps at 802, 803 and 804. In FIG. 8, the procedure has been repeated for each fragment to produce sixteen pieces (A through P) of dissimilar dimensions.

In another embodiment, the segmenting lines that bisect the image may not be aligned to either of the image borders, but may be at random angles of inclination to the image borders. This is best described by comparing FIG. 9 with FIG. 5. In FIG. 9, an image 901 corresponds to the image 501 in FIG. 5. The segmenting steps 902 and 903 correspond to 502 and 503; however they have been performed at random angles to produce the irregular fragments A, B, C and D. This approach may be similarly applied to the embodiments set out in FIG. 6, FIG. 7 and FIG. 8.

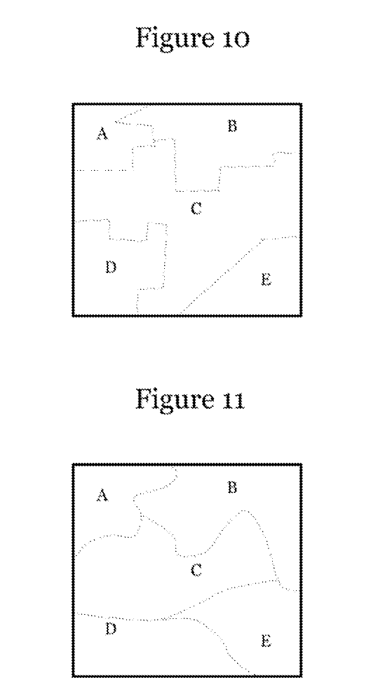

In other embodiments, the segmentation may not be performed along straight lines, but along non-linear paths through the image. This is best described with reference to FIG. 10, in which four irregular paths are chosen, which produce five irregular fragments, A, B, C, D and E. FIG. 11 depicts a variation of this embodiment, in which curved lines are generated and used to segment the image into fragments A, B, C, D and E.

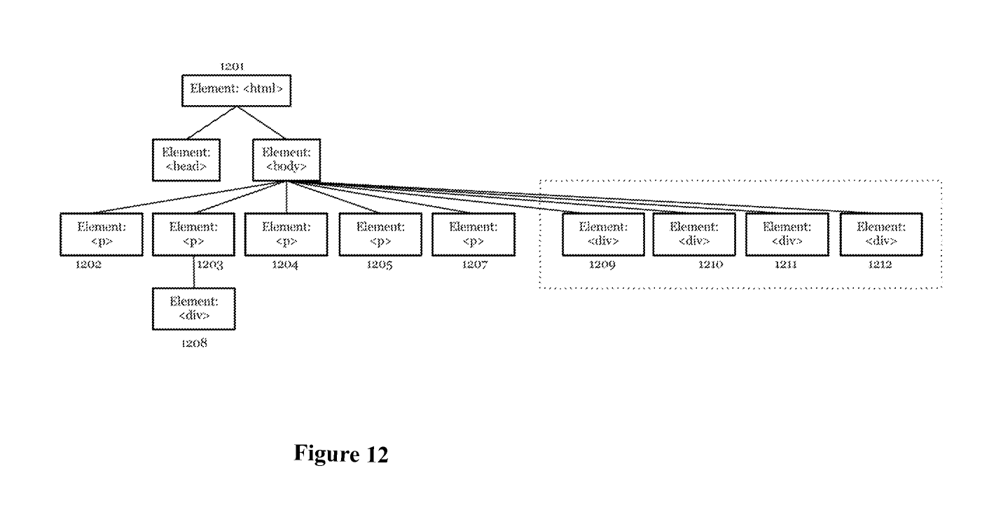

The fragment layout engine 404 receives the fragments from the fragmentation engine 403 and inserts corresponding elements into the HTML document. This is best understood with reference to FIG. 12. In comparing FIG. 12 with FIG. 2, elements 1202-1207 correspond to the paragraph elements 202-207 in FIG. 2. New HTML elements 1209 to 1212 are added to the HTML document, and are provided with display instructions that cause the rendering engine 402 to show the appropriate fragment of the image in each of them.

In FIG. 12, a spacer element 1208 is introduced in place of the original image element 208 of FIG. 2. The spacer element 1208 should be understood to refer to a transparent element of the web page of the same dimensions as the image that is to be protected from tampering. The spacer element 1208 serves to occupy the space that is normally consumed by the image 208. The spacer element 1208 thus provides empty space onto which the fragment layout engine 404 can arrange the fragments for correct visual display.

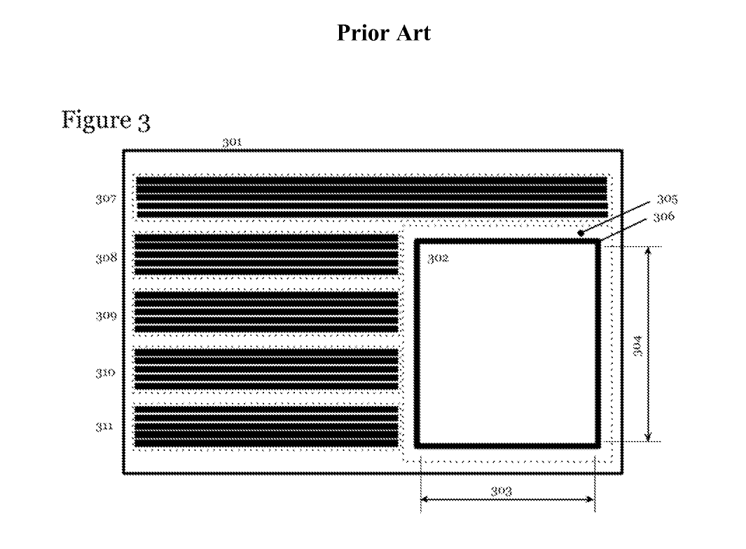

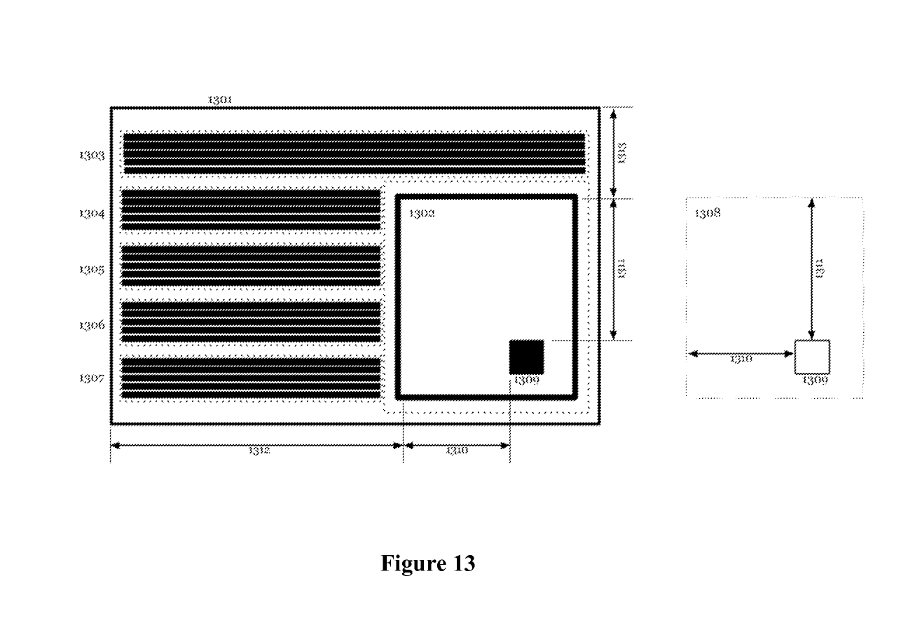

The fragment layout engine 404 now rearranges the fragments into position over the location of the spacer element 1208 so as to produce the original image. This is best described with reference to FIG. 13. In comparing FIG. 13 to FIG. 3, a web page 1301 corresponds to the web page 301 in FIG. 3, paragraphs 1303-1307 correspond to the paragraphs 307-311 respectively and a spacer 1302 is rendered in the position formerly occupied by the image 302.

The original position of a fragment 1309 relative to the original image 1308 is communicated by the fragmentation engine 403 to the fragment layout engine 404. The original position of the fragment 1309 may be in the form of its x-axis displacement 1310 and y-axis displacement 1311.

An x-axis distance 1312 and a y-axis distance 1313 of the spacer 1302 relative to the web page 1301 are also known to the fragment layout engine 404. The fragment layout engine 404 specifies new display instructions to the rendering engine 402 to alter the position of the fragment 1309 so that it is displayed at a location relative to the spacer that is equivalent to its original position relative to the image it originally formed part of. Thus, the fragment 1309 is positioned from the left of the web page by the sum of the distances 1312 and 1310, and from the top of the web page by the sum of the distances 1311 and 1313. This process is repeated for all fragments that have been produced by the fragmentation engine 403.

Consequently, the rendering engine 402 uses the display instructions specified by the fragment layout engine 404 to display the original image on the web page, without any of the HTML elements that cause it to display having any correspondence with the dimensions of the original image. The fragment elements are individually simple and depend on common features of HTML and CSS, making it difficult to accurately identify them for removal.

Another key benefit of this system is that it is unbeneficial for an ad blocking tool to tamper with the spacer element. If such a tool removed the spacer element, the rendering engine 402 would be unable to prevent other page elements (such as paragraphs 1303-1307) from overlapping with the displayed image, which would have the undesirable consequence of making the web page harder to read.

The words comprises/comprising when used in this specification are to specify the presence of stated features, integers, steps or components but does not preclude the presence or addition of one or more other features, integers, steps, components or groups thereof. It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

1. A method for displaying a web page element on a web page, comprising:
separating by a fragmentation engine a web page element, which when rendered on the web page has visual characteristics, into a plurality of fragments and generating display instructions for each of the fragments; and
arranging by a rendering engine the fragments on a web page according to the display instructions to replicate the visual characteristics of the web page element.

2. The method of claim 1, wherein the fragmentation engine comprises a fragment layout engine for receiving the fragments and generating the display instructions.

3. The method of claim 1, wherein:
the web page element is associated with a web page template, the web page element having border information defining borders of the rendered web page element within the template, the fragmentation engine defining fragments having borders within the border defined by the rendered web page element; and
separating the image into a plurality of fragments comprises segmenting the web page element along one or more lines between borders of the web page element to produce two or more fragments.

4. The method of claim 3, wherein the separating the web page element into a plurality of fragments comprises:
segmenting the web page element along at least one line from a first border to a second border of the web page element.

5. The method of claim 3, wherein the separating the web page element into a plurality of fragments comprises:
segmenting the web page element at at least one location on a left border of the web page element in an x-axis plane of the web page element, and at at least one location on a top border of the web page element in a y-axis plane of the web page element.

6. The method of claim 5, wherein the separating the web page element into a plurality of fragments comprises:
segmenting the web page element at two locations in the x-axis plane, and at two locations in the y-axis plane.

7. The method of claim 3, wherein the separating the web page element into a plurality of fragments comprises:
separating the fragments into a plurality of sub-fragments.

8. The method of claim 7, comprising recursively repeating the fragmentation procedure for each fragment to obtain a plurality of sub-fragments of each fragment.

9. The method of claim 3, wherein the separating the web page element into a plurality of fragments comprises segmenting the web page element along one or more lines at an inclined angle to one or more of the web page element borders.

10. The method of claim 3, wherein the segmenting is performed along linear and/or non-linear paths through the web page element.

11. The method of claim 10, wherein the segmenting is performed at non-linear paths through the web page element, the non-linear paths comprising curved lines.

12. The method of claim 3, wherein the web page element is segmented at random coordinates on the web page element borders.

13. The method of claim 3, comprising producing fragments of different dimensions to each other.

14. The method of claim 3, comprising inserting a spacer element having the same dimensions as the web page element into the web page.

15. The method of claim 14, wherein the fragmentation engine comprises a fragment layout engine for receiving the fragments and generating the display instructions, wherein the fragment layout engine rearranges the display elements into position over the location of the spacer element so as to replicate the visual characteristics of the web page element.

16. The method of claim 2, wherein the fragmentation engine communicates original positions of fragments relative to the original web page element to the fragment layout engine.

17. The method of claim 15, wherein the fragment layout engine specifies the display instructions to the rendering engine to alter the position of the fragments so as to be displayed at locations relative to the spacer element that are equivalent to their original positions relative to the web page element.

18. A system for displaying an web page element on a web page, comprising:
a fragmentation engine configured to separate a web page element, which when rendered on a web page has visual characteristics, into a plurality of fragments and to generate display instructions for each of the fragments; and
a rendering engine configured to arrange the fragments on a web page according to the display instructions to replicate the visual characteristics of the web page element.

19. A rendering engine configured to arrange a plurality of fragments of a web page element having visual characteristics according to display instructions for each of the fragments to replicate the visual characteristics of the web page element on a web page.

20. The rendering engine of claim 19, being provided as a plug-in or other executable application that functions with a web browser.

21. The rendering engine of claim 19 configured to receive from a remote server a plurality of fragments of an originating web page element, each of the fragments comprising display instructions providing information to the rendering agent to allow the rendering agent reconstruct the plurality of fragments into a composite image having visual characteristics similar to the originating web page element.

22. A web browser comprising the rendering engine of claim 20.

23. A computer application containing computer-readable instructions which when executed cause a computer to:
separate a web page element, which when rendered on a web page has visual characteristics, into a plurality of fragments and generate display instructions for each of the fragments; and
arrange the fragments on a web page according to the display instructions to replicate the visual characteristics of the web page element.

24. The computer application of claim 22, being implemented in a web browser.
